(19) United States
(12) Patent Application Publication
(10) Pub. No.: US 2020/0117216 A1
(43) Pub. Date: Apr. 16, 2020

(54) INFORMATION PROCESSING DEVICE AND STORAGE MEDIUM STORING PROGRAM

(71) Applicant: TOYOTA JIDOSHA KABUSHIKI KAISHA, Toyota-shi (JP)

(72) Inventors: Tae SUGIMURA, Miyoshi-shi (JP); Hirotaka KARUBE, Toyota-shi (JP); Kazuki MATSUMOTO, Ohgaki-shi (JP); Makoto MORI, Nagakute-shi (JP); Jun KONDO, Nissin-shi (JP)

(73) Assignee: TOYOTA JIDOSHA KABUSHIKI KAISHA, Toyota-shi (JP)

(21) Appl. No.: 16/527,511

(22) Filed: Jul. 31, 2019

(30) Foreign Application Priority Data
Oct. 10, 2018 (JP) 2018-192130

(51) Int. Cl. G05D 1/02; G06Q 10/06; G06Q 10/02; G05D 1/00; B60L 53/00

(52) U.S. Cl. CPC G05D 1/0291; G06Q 10/06315; B60L 2200/16; G05D 1/0088; B60L 53/00; G06Q 10/02

(57) ABSTRACT

An information processing device includes a registering unit, an obtaining unit, a predicting unit, a determining unit, and a vehicle relocating unit. The registering unit registers information on a destination where a predetermined event is held. The obtaining unit obtains current location information of vehicles movable around or within the destination. The predicting unit predicts, for each specific area, demand for the vehicles that are needed when the predetermined event is held at the destination. The determining unit determines, for each specific area, a difference between the number of available vehicles out of the vehicles of which current location information has been obtained by the obtaining unit and the number of vehicles predicted by the predicting unit. When the difference determined for each specific area by the determining unit is larger than a predetermined threshold, the vehicle relocating unit relocates the vehicles so as to reduce the difference.

### INCORPORATION BY REFERENCE

The disclosure of Japanese Patent Application No. 2018-192130 filed on Oct. 10, 2018 including the specification, drawings and abstract is incorporated herein by reference in its entirety.

### BACKGROUND

### 1. Technical Field

The disclosure relates to information processing devices and storage medium storing a program.

### 2. Description of Related Art

Recently, car sharing systems that allow multiple users to share a single vehicle have been becoming more popular. The car sharing systems are different from conventional car rental services in that users can rent a vehicle for shorter terms.

Ordinary cars are typically used as shared vehicles in the car sharing systems, but the use of electric ultra-compact mobility vehicles that are more compact with smaller turning radii and higher environmental performance than the ordinary cars has also been considered. For example, Japanese Patent Application Publication No. 2015-116855 (JP 2015-116855 A) discloses such an ultra-compact mobility vehicle.

The ultra-compact mobility vehicle disclosed in JP 2015-116855 A is a one- or two-seater vehicle whose overall length is smaller than, e.g., 2,500 mm that is the maximum allowed vehicle width in Japan.

### SUMMARY

When starting a new car sharing system business using vehicles including such ultra-compact mobility vehicles, it is necessary to determine the size of the system in view of feasibility of the business. In order to fully meet users' needs, it is desirable to increase the number of vehicles that can be used as shared cars (including ultra-compact mobility vehicles). However, increasing the number of shared cars may affect the feasibility of the business as it leads not only to an increase in cost for procurement and maintenance of vehicles but also to an increase in cost for procurement and maintenance of parking spaces at stations. It is therefore desirable to improve the utilization rate of vehicles that can be used as shared cars so as to meet users' needs as much as possible and ensure a profit.

The disclosure provides a technique capable of increasing the utilization rate of vehicles and improving users' convenience in car sharing systems.

An information processing device according to a first aspect of the disclosure includes: a registering unit configured to register information on a destination where a predetermined event is held; an obtaining unit configured to obtain current location information of vehicles movable around or within the destination; a predicting unit configured to predict, for each specific area, demand for the vehicles that are needed when the predetermined event is held at the destination; a determining unit configured to determine, for each specific area, a difference between the number of available vehicles out of the vehicles of which current location information has been obtained by the obtaining unit and the number of vehicles predicted by the predicting unit; and a vehicle relocating unit configured to relocate the vehicles, when the difference determined for each specific area by the determining unit is larger than a predetermined threshold, so as to reduce the difference.

In the above aspect, the vehicles may be small vehicles that can be relocated from a predetermined point within a facility of the destination to another predetermined point where the demand for the vehicles is higher than that at the predetermined point.

In the above aspect, the information processing device may further include: a battery charge monitoring unit configured to monitor battery charge levels of the available vehicles out of the vehicles of which current location information has been obtained by the obtaining unit.

In the above aspect, when it is determined by the battery charge monitoring unit that the battery charge levels of the vehicles are equal to or higher than a predetermined value, the vehicle relocating unit may relocate the vehicles in an autonomous drive mode to a location where the predicted number of vehicles is higher than the predicted number of vehicles at the current location.

In the above aspect, the vehicle relocating unit may include a transporting system that, when it is determined by the battery charge monitoring unit that the battery charge levels of the vehicles are less than the predetermined value, transports the vehicles to a point that allows the vehicles to be charged, and after the vehicles transported by the transporting system are charged, the vehicle relocating unit may relocate the charged vehicles in an autonomous drive mode to a location where the predicted number of vehicles is higher than the predicted number of vehicles at the current location.

In the above aspect, the vehicle may include an imaging device configured to capture an image within a facility of the destination, and the predicting unit may predict, for each specific area, the number of vehicles based on the information on the destination where the predetermined event registered in the registering unit is held and information on the image captured by the imaging device.

A second aspect of the disclosure relates to a storage medium storing a program that causes a computer to perform a process. The process includes: registering information on a destination where a predetermined event is held; obtaining current location information of vehicles relocatable to the destination; predicting, for each specific area, demand for the vehicles that are needed when the predetermined event is held; determining, for each specific area, a difference between the number of available vehicles and the predicted number of vehicles at the current location; and outputting, when the difference is larger than a predetermined value, information for relocating the vehicles so as to reduce the difference.

The disclosure can thus provide a technique capable of increasing the utilization rate of vehicles and improving users' convenience in car sharing systems.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing an example of the configuration of a car sharing system;

FIG. 2A is a diagram showing an example of the hardware configuration of an information processing device;

FIG. 2B is a diagram showing an example of the configuration of functional blocks of the information processing device;

FIG. 3A is a diagram showing a specific example of a user DB;

FIG. 3B is a diagram showing a specific example of a destination DB;

FIG. 4A is a diagram showing a specific example of a usage history DB;

FIG. 4B is a diagram showing a specific example of a vehicle information DB;

FIG. 5 is a diagram showing a specific example of a demand prediction DB;

FIG. 6 is a diagram showing an example of the configuration of a vehicle;

FIG. 7 is a diagram showing an example of the configuration of functional blocks of a vehicle;

FIG. 8 is a diagram showing a modification of the configuration of a vehicle;

FIG. 9 is a diagram showing a modification of the configuration of functional blocks of a vehicle;

FIG. 10 is a flowchart illustrating an example of a processing procedure that is performed by the information processing device;

FIG. 11A is a diagram showing an example of the state around a destination before a vehicle relocation process is performed:

FIG. 11B is a diagram showing an example of the state around the destination after the vehicle relocation process is performed;

FIG. 12A is diagram showing an example of the state within a destination before a vehicle relocation process is performed;

FIG. 12B is diagram showing an example of the state within the destination after the vehicle relocation process is performed; and

FIG. 13 is a diagram showing an example of high demand spots within the destination.

### DETAILED DESCRIPTION OF EMBODIMENTS

Embodiments of the disclosure will be described with reference to the accompanying drawings. Elements denoted by the same reference characters have the same or similar configuration.

System Configuration

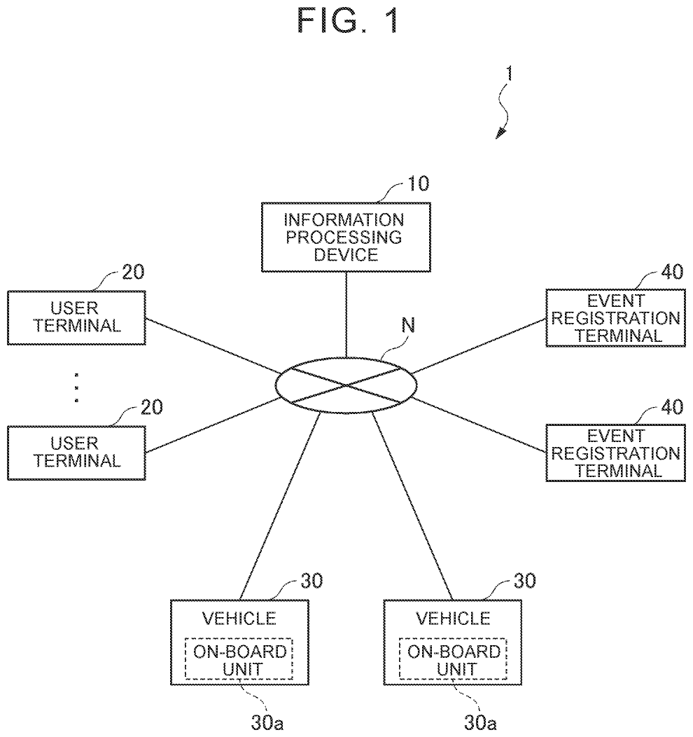

FIG. 1 is a diagram showing an example of the configuration of a car sharing system 1. The car sharing system 1 includes an information processing device 10, user terminals 20, and vehicles 30. Each vehicle 30 is equipped with an on-board unit 30a. The information processing device 10, the user terminal 20, and the on-board unit 30a can communicate with each other via a communication network N.

Sharing of the same vehicle 30 by multiple users is generally called car sharing. For example, there are two types of car sharing, round-trip car sharing and one-way car sharing. The round-trip car sharing requires the users to return vehicles to the same station as the pickup station, and the one-way car sharing allows the users to return vehicles to stations other than the pickup station. However, the car sharing described herein is not limited to these two types of car sharing. That is, the car sharing described herein includes any type of car sharing that allows users to share the same vehicle 30.

The disclosure is described below with respect to an example in which the vehicle 30 communicates with the information processing device 10 via the communication network N and the vehicle 30 and the information processing device 10 are implemented as separate systems. However, the disclosure is not limited to this example. For example, the disclosure can be implemented as what is called a standalone system by the vehicle 30 alone equipped with the information processing device 10 having functions such as a function to process or output information stored in a storage medium.

The information processing device 10 accepts reservations for car sharing from the users and registers the accepted reservations on a database. Users' usage histories are also registered on the database. The usage history includes trip start and end points, trip start and end times, and vehicle information (vehicle color, model, etc.) regarding each vehicle the user used in the past. The information processing device 10 also registers information on destinations where predetermined events are held (event information (event schedules, times, etc.), store locations, etc.) on the database. For example, in the present embodiment, the information processing device 10 predicts, for each specific area, demand for vehicles that are needed when a predetermined event is held at a destination and performs a process of relocating vehicles based on the predicted demand. The functions of the information processing device 10 will be described later in detail.

The user terminal 20 is a terminal that is used by the user of the car sharing system 1. For example, the user terminal 20 is a smartphone, a tablet terminal, a mobile terminal, a notebook computer, etc. The user terminal 20 displays a screen for the user to make a reservation for car sharing. The user can make a reservation for car sharing by entering various kinds of information (vehicle model and color, trip start and end points, vehicle pickup and drop-off times, vehicle pickup and drop-off locations, etc.) on the screen.

The vehicle 30 is a one- or two-seater vehicle that is used by the user and is equipped with the on-board unit 30a. For example, the vehicle 30 is an electric ultra-compact mobility vehicle that is more compact with a smaller turning radius than ordinary cars. The configuration of the ultra-compact mobility vehicle will be described later.

In the case where the vehicle 30 is a manually operated vehicle, the on-board unit 30a may be a device capable of displaying a route to a destination which is output from the information processing device 10 (e.g., a navigation system). In the case where the vehicle 30 is an autonomous vehicle, the on-board unit 30a performs various kinds of control for autonomously operating the vehicle 30 along a route to a destination which is output from the information processing device 10.

An event registration terminal 40 is a terminal for registering information on user's destination, such as event information and store locations, on the information processing device 10. For example, the event registration terminal 40 is a smartphone, a tablet terminal, a mobile terminal, a notebook computer, etc. An individual or corporate who holds an event, an individual or corporate who runs a store, etc. can use the event registration terminal 40 to register various kinds of information on the event (event summary, location, date and time, etc.) and information on the store (store summary, location, products that are sold at the store, etc.) on the information processing device 10. The user can thus register his/her schedule (e.g., his/her interest in an event P, etc.) by checking the event information and the store information registered on the information processing device 10 and selecting the place he/she wants to go.

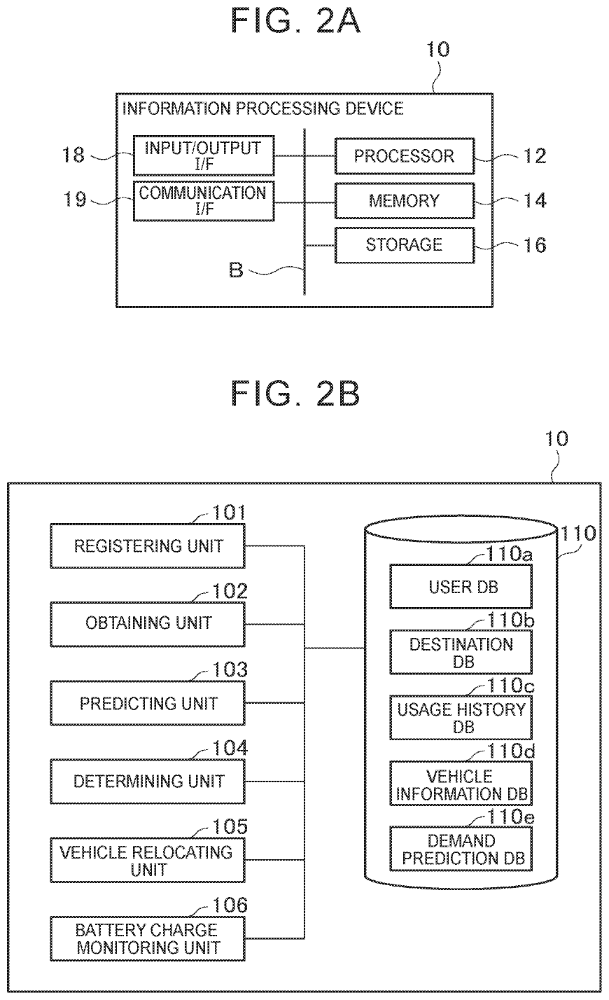

Next, the configuration of the information processing device 10 will be described. FIG. 2A is a diagram showing an example of the hardware configuration of the information processing device 10. The information processing device 10 includes a processor 12, a memory 14, a storage 16, an input/output interface (input/output I/F) 18, and a communication interface (communication I/F) 19. The components of the hardware of the information processing device 10 are connected to each other via, e.g., a bus B.

The information processing device 10 implements functions and/or methods described in the present embodiment by cooperation among the processor 12, the memory 14, the storage 16, the input/output I/F 18, and the communication I/F 19.

The processor 12 performs functions and/or methods that are implemented by codes or commands included in a program stored in the storage 16. For example, the processor 12 includes a central processing unit (CPU), a micro processing unit (MPU), a graphics processing unit (GPU), a microprocessor, a processor core, a multiprocessor, an application-specific integrated circuit (ASIC), a field programmable gate array (FPGA), etc.

The memory 14 temporarily stores therein a program loaded from the storage 16 and provides a working area for the processor 12. Various data that is generated while the processor 12 is executing the program is also temporarily stored in the memory 14. For example, the memory 14 includes a random access memory (RAM), a read only memory (ROM), etc.

The storage 16 stores a program etc. to be executed by the processor 12. For example, the storage 16 includes a hard disk drive (HDD), a solid-state drive (SSD), a flash memory, etc.

The input/output I/F 18 includes an input device for receiving various operations for the information processing device 10 and an output device for outputting the result of processing performed by the information processing device 10.

The communication I/F 19 transmits and receives various data via the network. This communication may be either wired communication or wireless communication, and any communication protocol may be used as long as the communication can be made. The communication I/F 19 has a function to communicate with the vehicles 30 via the network. The communication I/F 19 transmits various data to another information processing device(s) or the vehicles 30 according to commands from the processor 12.

The program of the present embodiment may be provided as a program stored in a computer-readable storage medium. The storage medium can store the program in a “non-transitory tangible medium.” For example, the program includes a software program and a computer program.

At least a part of processing of the information processing device 10 may be implemented by cloud computing formed by one or more computers. At least a part of processing of the information processing device 10 may be performed by another information processing device(s). In this case, at least a part of processing of the functional units implemented by the processor 12 may be performed by another information processing device(s).

Functional Block Configuration

FIG. 2B is a diagram showing an example of the configuration of functional blocks of the information processing device 10. The information processing device 10 includes a registering unit 101, an obtaining unit 102, a predicting unit 103, a determining unit 104, a vehicle relocating unit 105, and a battery charge monitoring unit 106.

The registering unit 101, the obtaining unit 102, the predicting unit 103, the determining unit 104, the vehicle relocating unit 105, and the battery charge monitoring unit 106 can be implemented by executing a program stored in the memory by the CPU of the information processing device 10. This program can be stored in a storage medium. The storage medium having this program stored therein may be a non-transitory storage medium. The non-transitory storage medium is not particularly limited, but for example, may be a storage medium such as a USB memory or a CD-ROM. A storage unit 110 can be implemented by using a memory or storage device included in the information processing device 10.

The registering unit 101 accepts user registrations for the car sharing system 1 from the users and registers information entered by each user such as his/her name on a user DB 110a. The registering unit 101 also registers information (event schedule, time, etc.) that a predetermined event is held at a specific one of a plurality of destinations registered in advance on a destination DB 110b by the users (individuals or corporates who hold events, individuals or corporates who run stores, etc.) different from the users who use the car sharing system 1. The registering unit 101 stores users' vehicle usage histories (trip start and end points, trip start and end times, and vehicle information (vehicle model etc.)) in a usage history DB 110c based on the user registration information received from the users.

The obtaining unit 102 obtains the current locations of the vehicles 30 and registers the current locations of the vehicles 30 together with the information on the reservations accepted from the users on a vehicle information DB 110d. The vehicle information DB 110d stores therein the current locations of the vehicles 30 (standby locations of the vehicles 30) and also stores therein information on whether there is any available vehicle 30 and, when any reservation has been registered, stores therein information indicating the date and time of each reservation.

The predicting unit 103 predicts, for each specific area, the number of vehicles that are needed when a predetermined event is held at a specific one of the plurality of destinations registered on the destination DB 110b. For example, the number of vehicles that are needed includes information such as high demand vehicle models and colors, the numbers of vehicles of the high demand vehicle models and colors, etc. For example, the predicting unit 103 may predict the number of vehicles that are needed, based on the users' vehicle usage histories (trip start and end points and trip start and end times) for the same event held in the past (if the same event has never been held, for an event(s) similar to this event). In the case where the vehicles are equipped with an imaging device capable of capturing images within a facility of a destination, the predicting unit 103 may predict the number of vehicles that are needed for each specific area based on information on a destination where a predetermined event registered on the registering unit 101 is held and information on images captured by the imaging device.

The determining unit 104 determines, for each specific area, the difference between the number of available vehicles out of the vehicles 30 of which current location information has been obtained by the obtaining unit 102 and the number of vehicles that are needed which has been predicted by the predicting unit 103 (the predicted number of vehicles).

When the difference determined for each specific area by the determining unit 104 is larger than a predetermined threshold, the vehicle relocating unit 105 relocates the vehicles 30 so as to reduce the difference. For example, in the case where the predetermined threshold is 10, and five vehicles are currently available in a predetermined area and the number of vehicles predicted for the predetermined area by the predicting unit 103 is 20, the difference in the predetermined area is larger than the predetermined threshold. The vehicle relocating unit 105 therefore relocates the vehicles 30 to the predetermined area so as to reduce the difference.

In the present embodiment, the predetermined threshold that is used as a reference value for the determination by the determining unit 104 is set to any desired value. The predetermined threshold may be set to the same value for all the areas or may be set to different values depending on the area. For example, the predetermined threshold may be set to a small value for high demand areas (that is, the process of relocating the vehicles is performed even if the difference is relatively small) and set to a large value for low demand areas (that is, the process of relocating the vehicles is not performed even if the difference is relatively large).

For example, the vehicle relocating unit 105 performs a process of relocating the vehicles that have not been reserved by the users (vehicles that are available) and are on standby in an area where the number of vehicles predicted by the predicting unit 103 is small to an area where the number of vehicles predicted by the predicting unit 103 is large. For example, the process that is performed by the vehicle relocating unit 105 may be a process of collecting (relocating) the vehicles 30 by a predetermined transporting system (not shown), a process of relocating the vehicles 30 by an individual who holds an event etc., or a process of outputting signals for operating the vehicles 30 in an autonomous drive mode along a predetermined route. In the case where the vehicles 30 are vehicles that can be operated autonomously (hereinafter also referred to as the “autonomous vehicles”), the on-board units 30a perform various kinds of control for autonomously operating the vehicles 30 along a route output from the vehicle relocating unit 105.

Even in the case where the vehicles 30 are autonomous vehicles, a vehicle supervisor including an individual who holds an event etc. (e.g., the owner of the car sharing system etc.) may relocate the vehicles 30 without switching the vehicles 30 to the autonomous drive mode in which the vehicles 30 are autonomously operated along a route output from the vehicle relocating unit 105. That is, the process that is performed by the vehicle relocating unit 105 may be a process of outputting information for relocating the vehicles that have not been reserved by the users to the vehicle supervisor.

The battery charge monitoring unit 106 monitors the battery charge levels of the vehicles 30 stored in the car sharing system 1. For example, in the present embodiment, the battery charge monitoring unit 106 may monitor the battery charge levels of the vehicles 30 of which current location information has been obtained by the obtaining unit 102.

When it is determined by the battery charge monitoring unit 106 that the battery charge levels of the vehicles 30 are equal to or higher than a predetermined value, the vehicle relocating unit 105 performs a process of relocating the vehicles 30 to another location(s) where the predicted number of vehicles (the number of vehicles predicted by the predicting unit 103) is larger than the predicted number of vehicles at the current location. In this case, the process of relocating the vehicles 30 may be performed in the autonomous drive mode (e.g., the on-board units 30a mounted on the vehicles 30 may perform various kinds of control for autonomously operating the vehicles 30).

When it is determined by the battery charge monitoring unit 106 that the battery charge levels of the vehicles 30 are less than the predetermined value, the vehicle relocating unit 105 performs a process (collecting process) of transporting the vehicles 30 to a point where the vehicles 30 can be charged by the predetermined transporting system (not shown). After the vehicles 30 transported by the transporting system are charged, the vehicle relocating unit 105 performs the process of relocating the vehicles 30 to another location(s) where the number of vehicles predicted by the predicting unit 103 is larger than the predicted number of vehicles at the current location.

The predetermined value of the battery charge level which is preset by the battery charge monitoring unit 106 (the value that is used as a reference value for determining if the process of transporting the vehicles to a point where the vehicles can be charged should be performed) is set to any desired value. For example, the predetermined value may be set to a reference value for determining if the battery charge levels of the vehicles are high enough to relocate the vehicles to another location(s) where the number of vehicles predicted by the predicting unit 103 is larger than the predicted number of vehicles at the current location.

Next, specific examples of the user DB 110a, the destination DB 110b, the usage history DB 110c, the vehicle information DB 110d, and a demand prediction DB 110e will be described.

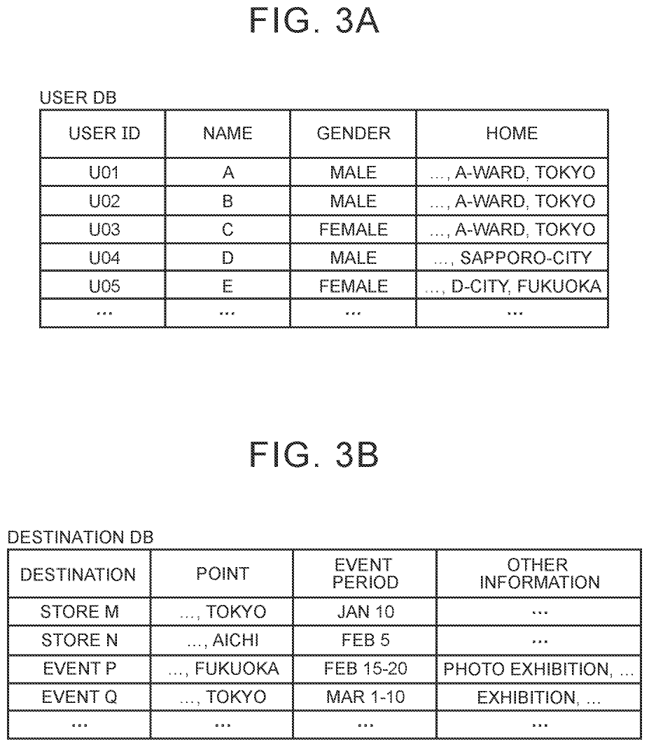

FIG. 3A shows a specific example of the user DB 110a. Identifiers for uniquely identifying the users in the car sharing system 1 are stored in “User ID.” For example, a user ID may be provided by the information processing device 10 when the user registers for the car sharing system 1 (hereinafter this registration is simply referred to as “user registration”). The name entered during user registration is stored in “Name.” The gender entered during user registration is stored in “Gender.” Information (address, latitude and longitude, etc.) indicating the location of user's home entered during user registration is stored in “Home.”

FIG. 3B shows a specific example of the destination DB 110b. Store names, event names, etc. are stored in “Destination.” Not only stores and events but also any destination of which location can be specified can be stored in “Destination.” Information (address, latitude and longitude, etc.) indicating the location of each destination is stored in “Point.” In the case where an event that is held for only a limited period is registered, the period of the event is stored in “Event Period.” Various kinds of information on each destination such as introduction of products that are sold at stores and event summary (e.g., photo exhibition, exhibition) are stored in “Other Information.”

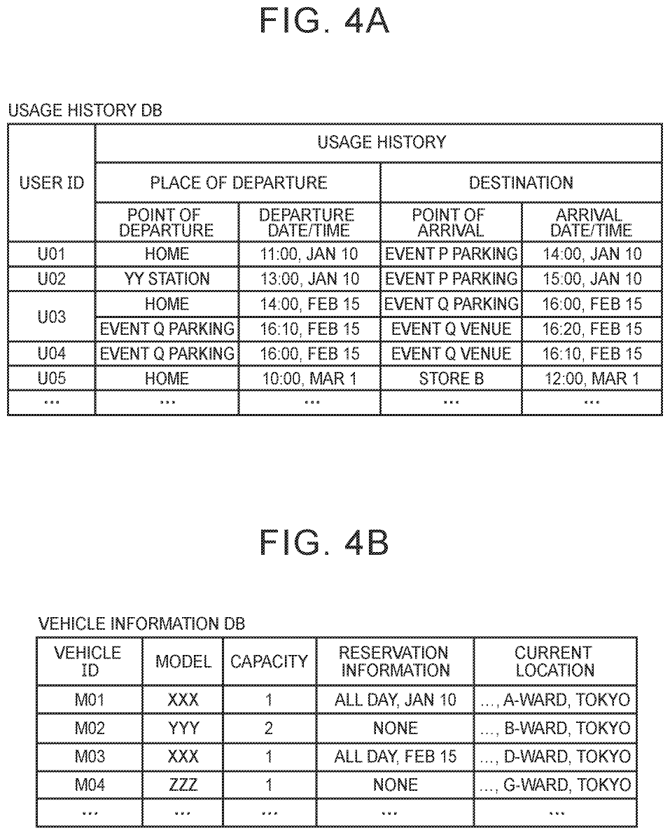

FIG. 4A shows a specific example of the usage history DB 110c. Since “User ID” is the same as “User ID” in the user DB 110a, description thereof will be omitted. The history of each user's actual usage of the car sharing system 1 including information entered by each user to the information processing device 10 via the user terminal 20 is stored in “Usage History.” “Usage History” contains “Point of Departure” and “Departure Date and Time” as information on the place of departure and contains “Point of Arrival” and “Arrival Date and Time” as information on the destination. The point of arrival desired by the user may be registered in “Point of Arrival” or the destination selected from those registered on the destination DB 110b by the user may be registered in “Point of Arrival.”

In the example of FIG. 4A, for the user whose user ID is “U01,” the usage history indicating that the user departed from his/her home at 11:00 on January 10 and arrived at the parking lot for the event P at 14:00 on January 10 is stored in the usage history DB 110c. For the user whose user ID is “U02,” the usage history indicating that the user departed from YY station at 13:00 on January 10 and arrived at the parking lot for the event P at 15:00 on January 10 is stored in the usage history DB 110c. For the user whose user ID is “U03,” the usage history indicating that the user departed from his/her home at 14:00 on February 15, arrived at the parking lot for the event Q at 16:00 on February 15, departed from the parking lot for the event Q at 16:10 on February 15, and arrived at the venue of the event Q at 16:20 on February 15 is stored in the usage history DB 110c.

FIG. 4B shows a specific example of the vehicle information DB 110d. Identifiers for uniquely identifying the vehicles 30 stored in the car sharing system 1 are stored in “Vehicle ID.” For example, the vehicle IDs may be the license plate numbers of the vehicles 30. The vehicle models etc. of the vehicles 30 are stored in “Vehicle Model.” The seating capacities of the vehicles 30 are stored in “Capacity.” The period during which the vehicle 30 has been reserved (that is, the period during which the vehicle 30 is not available) is stored in “Reservation Information.” Information on the current locations of the vehicles 30 (e.g., information indicating the places where the vehicles 30 are on standby) are stored in “Current Location.” Since the current location is also the place where the user can pick up the vehicle 30 (possible pickup location), the current location may also be called a pickup station of the vehicle 30.

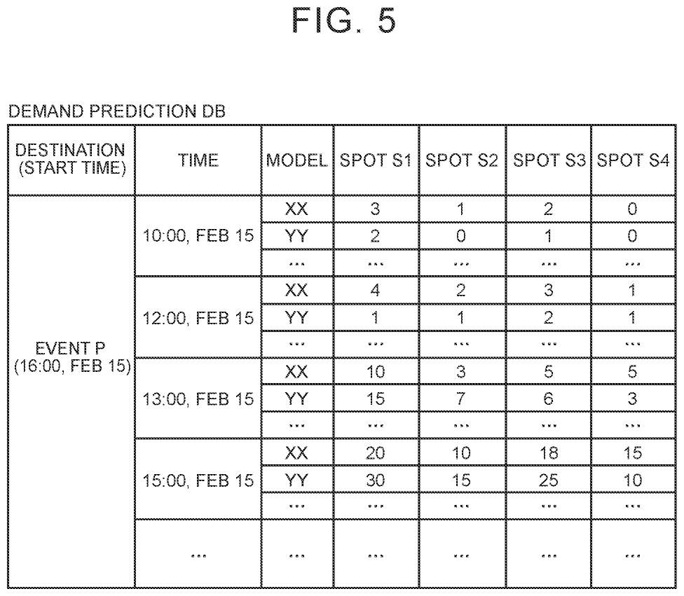

FIG. 5 shows a specific example of the demand prediction DB 110e. A store name or an event name, information associated with an event including the event start time, etc. are stored in “Destination.” Not only stores and events but also any destination of which location can be specified can be stored in “Destination.” The times for which an individual who holds an event etc. wants to know the vehicle demand are stored in “Time.” These times are preset by the individual who holds an event etc. Of the vehicles 30 stored in the car sharing system 1, those vehicle models for which high demand is expected for an event to be held at a destination are stored in “Vehicle Model.” Those spots around the destination or within a facility (e.g., a parking lot, an event venue, etc.) of the destination where high vehicle demand is expected are stored in “Spot S1” to “Spot S4.”

In the example of FIG. 5, the predicted numbers of vehicles (the predicted numbers of vehicles of model XX and model YY) that are needed at four spots (spots S1 to S4) at four times (10:00, 12:00, 13:00, 15:00) on February 15 for the event P that will start at 16:00 on February 15 are stored in the demand prediction DB 110e. In FIG. 5, four times are shown in “Time,” two vehicle models are shown in “Vehicle Model,” and four spots are shown in “Spot.” However, the number of times, the number of vehicle models, and the number of spots are not limited to these and may be increased or decreased as desired according to the type of the event, when the event is held, etc. Vehicle demand for a predetermined event (e.g., the event P) that is held at a destination is predicted for each specific area.

The vehicle demand that is stored in the demand prediction DB 110e may be predicted based on the users' usage histories stored in the usage history DB 110c. For example, which vehicle models will be needed at what times and at which spots (at which spot the vehicle demand is particularly high) may be predicted based on the users' vehicle usage histories for the same event P held in the past, namely the users' vehicle usage histories around the location of the event P or within a facility of the event P (trip start and end points, vehicle pickup and drop-off times, etc.).

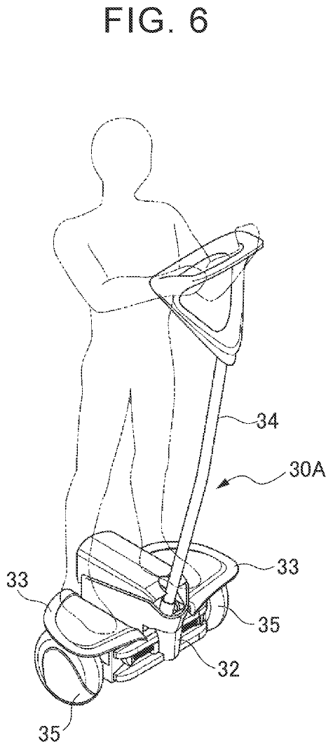

The configuration of a vehicle that is applied to the present embodiment will be described. FIG. 6 is a perspective view showing the schematic configuration of the vehicle (hereinafter the vehicle shown in FIG. 6 is referred to as the mobile inverted pendulum 30A).

For example, the mobile inverted pendulum 30A includes a vehicle body 32, a pair of (right and left) step portions 33, an operation handle 34, and a pair of (right and left) drive wheels 35. The step portions 33 are attached to the vehicle body 32, and an occupant steps on the step portions 33. The operation handle 34 is attached to the vehicle body 32 such that it can be tilted, and the occupant holds the operation handle 34. The drive wheels 35 are rotatably attached to the vehicle body 32.

For example, the mobile inverted pendulum 30A is configured as a coaxial two-wheeled vehicle in which the drive wheels 35 are coaxially disposed and which moves while maintaining its self-balanced state. The mobile inverted pendulum 30A moves forward and backward as the occupant shifts his/her center of gravity forward and backward to tilt the step portions 33 of the vehicle body 32 forward and backward. The mobile inverted pendulum 30A turns right and left as the occupant shifts his/her center of gravity to the right and left to tilt the step portions 33 of the vehicle body 32 to the right and left. Although such a coaxial two-wheeled vehicle is herein used as the mobile inverted pendulum 30A, the disclosure is not limited to this and is applicable to any mobility device that moves while maintaining its self-balanced state.

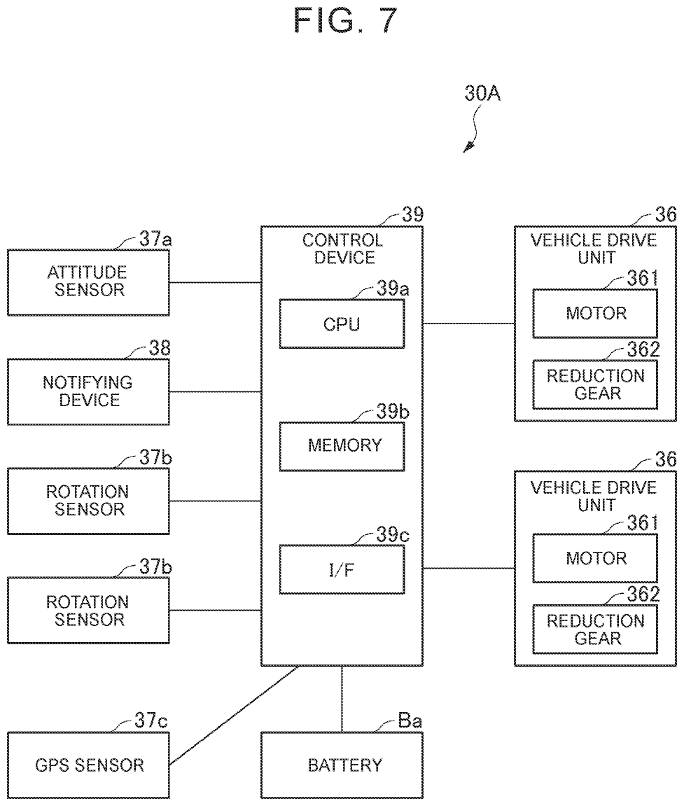

FIG. 7 is a block diagram showing the schematic system configuration of the mobile inverted pendulum according to the embodiment of the disclosure. The mobile inverted pendulum 30A of the embodiment of the disclosure includes a pair of wheel drive units 36, an attitude sensor 37a, a pair of rotation sensors 37b, a control device 39, and a battery Ba. Each wheel drive unit 36 drives a corresponding one of the drive wheels 35. The attitude sensor 37a detects the attitude of the vehicle body 32 etc. Each rotation sensor 37b detects rotation information of a corresponding one of the drive wheels 35. The control device 39 controls the wheel drive units 36. The battery Ba supplies electric power to the wheel drive units 36 and the control device 39.

The wheel drive units 36 are contained in the vehicle body 32 and drive the pair of drive wheels 35. Each wheel drive unit 36 can independently rotationally drive a corresponding one of the drive wheels 35. For example, each wheel drive unit 36 can be formed by a motor 361 and a reduction gear 362 coupled to a rotary shaft of the motor 361 so that power can be transmitted to the reduction gear 362.

The attitude sensor 37a is mounted in the vehicle body 32. The attitude sensor 37a detects and outputs attitude information of the vehicle body 32, the operation handle 34, etc. The attitude sensor 37a detects attitude information during traveling of the mobile inverted pendulum 30A and is formed by, e.g., a gyro sensor, an acceleration sensor, etc. When the occupant tilts the operation handle 34 forward or backward, the step portions 33 are tilted in the same direction. The attitude sensor 37a detects attitude information corresponding to this tilt. The attitude sensor 37a outputs the detected attitude information to the control device 39.

The rotation sensor 37b is mounted on each drive wheel 35 etc. Each rotation sensor 37b can detect rotation information of a corresponding one of the drive wheels 35 such as rotation angle, rotational angular velocity, and rotational angular acceleration. For example, each rotation sensor 37b is formed by a rotary encoder, a resolver, etc. Each rotation sensor 37b outputs the detected rotation information to the control device 39.

A GPS sensor 37c that obtains current location information of the mobile inverted pendulum 30A may be provided. For example, the GPS sensor 37c is a part of a positioning system using artificial satellites and accurately measures the position (latitude, longitude, and altitude) of any point on the earth by receiving radio waves from a large number of GPS satellites. The mobile inverted pendulum 30A may be equipped with an imaging device and a communication device.

For example, the battery Ba is contained in the vehicle body 32. The battery Ba is formed by a lithium-ion battery etc. The battery Ba supplies electric power to the wheel drive units 36, the control device 39, other electronic devices, etc.

The control device 39 generates and outputs control signals for drivingly controlling each wheel drive unit 36, based on the detection values output from various sensors mounted on the mobile inverted pendulum 30A. For example, the control device 39 performs predetermined calculations based on the attitude information output from the attitude sensor 37a, the rotation information of each drive wheel 35 output from each rotation sensor 37b, etc. and outputs necessary control signals to each wheel drive unit 36. For example, the control device 39 performs self-balancing control to maintain the self-balanced state of the mobile inverted pendulum 30A by controlling each wheel drive unit 36.

A notifying device 38 is an example of a notifying unit. The notifying device 38 notifies the occupant according to notification signals from the control device 39. For example, the notifying device 38 is formed by a speaker that outputs sound, lights that turn on warning lamps or make the warning lamps flash, a vibrating device that vibrates the vehicle body 32, the operation handle 34, etc., a display that displays warnings, etc.

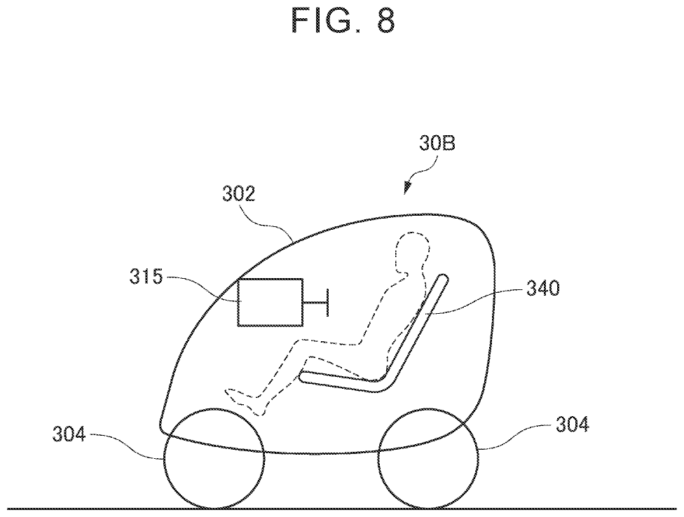

A modification of the vehicle will be described. FIG. 8 is a perspective view showing the schematic configuration of the vehicle of the modification (the vehicle shown in FIG. 8 is hereinafter referred to as the personal mobility vehicle 30B).

For example, the personal mobility vehicle 30B includes a vehicle body 302, a seat unit 340, an operation unit 315, and a pair of (right and left) drive wheels 304. The seat unit 340 is attached to the vehicle body 302, and an occupant (driver) sits on the seat unit 340. The operation unit 315 is held by the occupant and allows the occupant to operate the personal mobility vehicle 30B. The drive wheels 304 are rotatably attached to the vehicle body 302.

For example, the personal mobility vehicle 30B according to the present embodiment is a small one- or two-seater vehicle and may have two wheels 304 in the front and one in the rear. Movement of the personal mobility vehicle 30B may be controlled by operating the personal mobility vehicle 30B by the driver. However, the personal mobility vehicle 30B may be switched to an autonomous drive mode in which the personal mobility vehicle 30B is controlled to move autonomously based on images captured by an imaging device 370 described below.

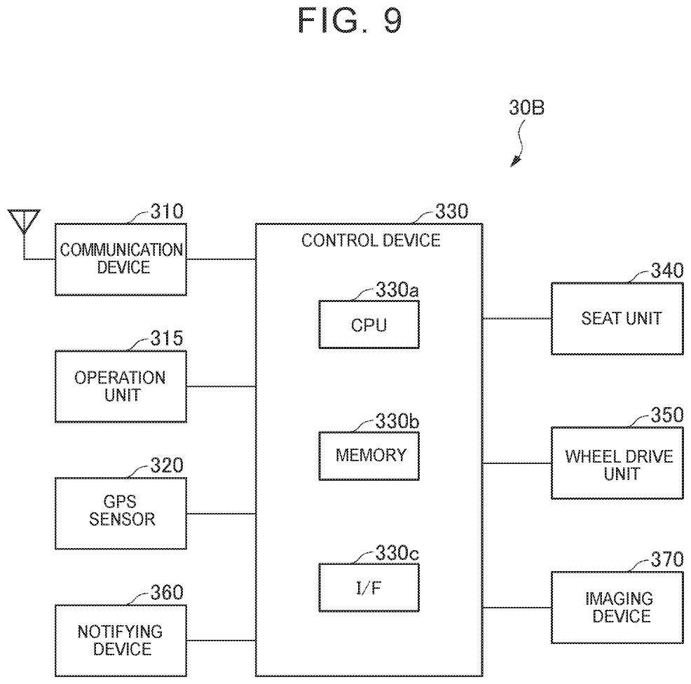

FIG. 9 is a block diagram showing the schematic system configuration of the personal mobility vehicle 30B. The personal mobility vehicle 30B of the present embodiment includes a pair of wheel drive units 350, a seat unit 340, a communication device 310, an operation unit 315, a GPS sensor 320, a notifying device 360, and an imaging device 370. Each wheel drive unit 350 drives a corresponding one of the drive wheels 304. An occupant can sit on the seat unit 340. The communication device 310 allows the personal mobility vehicle 30B to communicate with an external device. The operation unit 315 allows the occupant to operate the personal mobility vehicle 30B. The GPS sensor 320 obtains location information. The notifying device 360 can output sound. The imaging device 370 captures images.

The GPS sensor 320 obtains current location information of the personal mobility vehicle 30B. For example, the GPS sensor 320 is a positioning system using artificial satellites and accurately measures the position (latitude, longitude, and altitude) of any point on the earth by receiving radio waves from a large number of GPS satellites.

A control device 330 generates and outputs control signals for drivingly controlling each wheel drive unit 350, based on the detection values of various sensors mounted on the personal mobility vehicle 30B and the operation performed by the occupant using the operation unit 315.

The control device 330 has a CPU 330a, a memory 330b, and an I/F 330c in order to implement various processes. The CPU 330a performs functions and/or methods that are implemented by codes or commands included in a program stored in the memory 330b.

The memory 330b stores a program therein and provides a working area for the CPU 330a. Various data that is generated while the CPU 330a is executing the program is also temporarily stored in the memory 330b. The memory 330b includes, e.g., a random access memory (RAM), a read only memory (ROM), etc.

The I/F 330c includes an input device for receiving various operations for the control device 330 and an output device for outputting the result of processing performed by the control device 330.

The seat unit 340 is a seat unit on which the occupant sits and may be reclinable.

The wheel drive units 350 are contained in the vehicle body 302. Each wheel drive unit 350 drives the pair of (right and left) drive wheels 304 or the one drive wheel 304 in the rear.

The notifying device 360 is a specific example of a notifying unit. The notifying device 360 notifies the occupant or a person outside the vehicle according to notification signals from the control device 330. For example, the notifying device 360 is formed by a speaker that outputs sound, etc.

For example, the imaging device 370 is disposed at such a position that it captures images ahead of the personal mobility vehicle 30B. The imaging device 370 outputs captured images ahead of the personal mobility vehicle 30B to the control device 330.

The vehicle that is applied to the present embodiment is not limited to cars for about one or two passengers (ultra-compact mobility vehicles) which are compact with small turning radii and which are smaller than mini-vehicles. The vehicle that is applied to the present embodiment includes vehicles other than the ultra-compact mobility vehicles, such as ordinary cars.

Processing Procedure

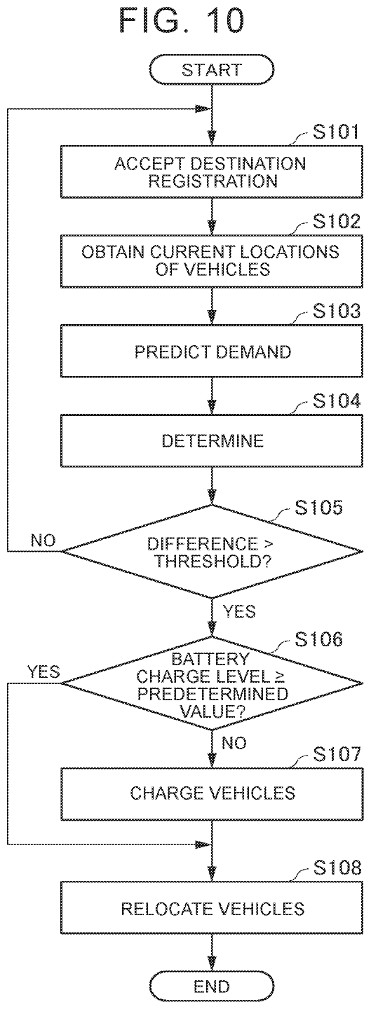

Next, the processing procedure that is performed by the information processing device 10 will be described. FIG. 10 is a flowchart illustrating an example of the processing procedure that is performed by the information processing device 10. It is herein assumed that the database (storage unit 110) described above has stored therein data including users' usage histories of the car sharing system 1 etc.

In step S101, the registering unit 101 registers information on a destination where a predetermined event is held, based on the information entered by an individual who holds the event etc. This step may be omitted when it is assumed that data about the destination has already been stored.

In step S102, the obtaining unit 102 obtains the current locations of the vehicles registered in the car sharing system 1 and stores the obtained data in the vehicle information DB 110d. The vehicle information DB 110d contains information on vehicle reservations made by the users. Of the vehicles of which current location information has been obtained by the obtaining unit 102, information on reserved vehicles (that is, unavailable vehicles) and information on available vehicles are separately stored in the vehicle information DB 110d. In the case where the current locations of the vehicles are obtained by the obtaining unit 102 in step S102, the battery charge levels of the vehicles are monitored by the battery charge monitoring unit 106 and are managed by the database (storage unit 110).

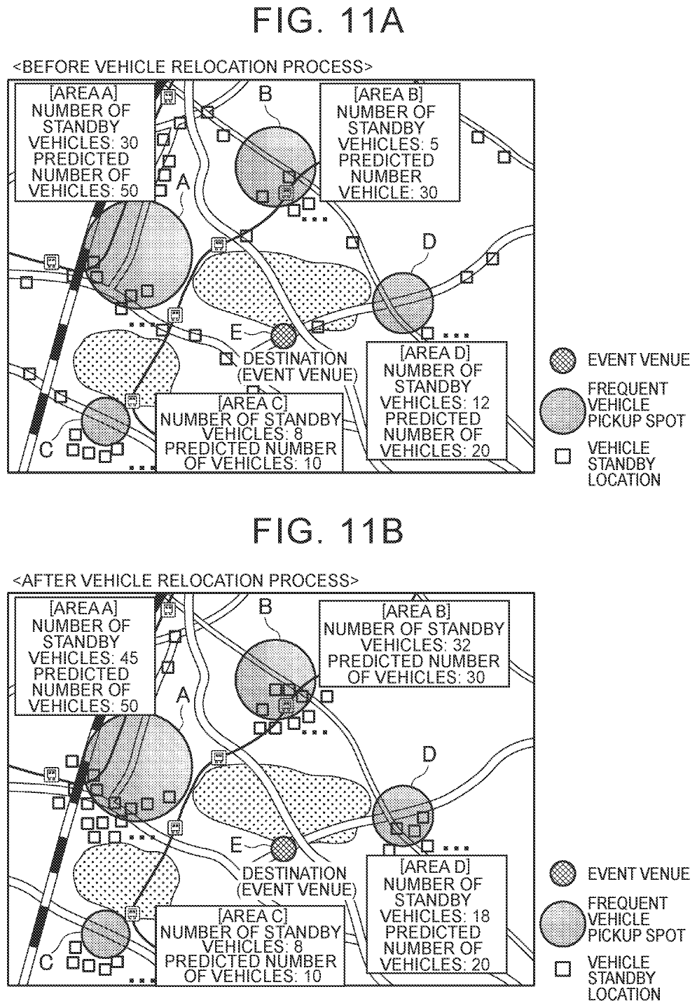

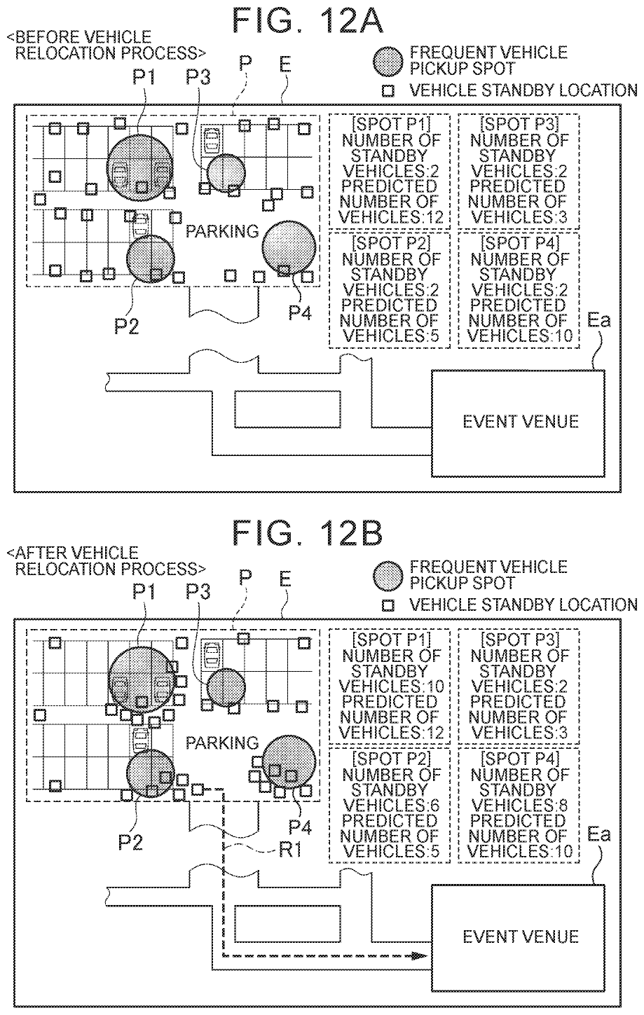

In step S103, the predicting unit 103 predicts vehicle demand for each specific area. As described above, the predicting unit 103 predicts vehicle demand for each specific area based on the type and details of the event and the users' usage histories (trip start and end points, vehicle pickup and drop-off times, etc.). FIGS. 11A, 11B and FIGS. 12A, 12B show examples of the vehicle demand prediction.

In the example of FIG. 11A, the number of vehicles that are needed around a destination E when a predetermined event is held at the destination E (the number of vehicles predicted by the predicting unit 103) is shown for each specific area. Specifically, in FIG. 11A, areas A, B, C, and D are presumed to be frequent vehicle pickup (high demand) spots, and the numbers of vehicles predicted by the predicting unit 103 for the areas A, B, C, and D are 50, 30, 10, and 20, respectively.

In the example of FIG. 12A, the number of vehicles that are needed within a facility of the destination E when a predetermined event is held at the destination E (the number of vehicles predicted by the predicting unit 103) is shown for each specific area in a parking area P in the destination E. Specifically, in FIG. 12A, spots P1, P2, P3, and P4 in the parking area P are presumed to be frequent vehicle pickup spots (high demand spots), and the numbers of vehicles that are needed (the number of vehicles predicted by the predicting unit 103) for the spots P1, P2, P3, and P4 are 12, 5, 3, and 10, respectively.

In step S104, the determining unit 104 determines, for each specific area, the difference between the number of available vehicles out of the vehicles of which current location information has been obtained by the obtaining unit 102 and the number of vehicles predicted by the predicting unit 103.

In the example of FIG. 11A, the number of available vehicles (the number of vehicles that are currently on standby) out of the vehicles of which current location information has been obtained by the obtaining unit 102 is 30, 5, 8, and 12 in the areas A, B, C, and D, respectively. The determining unit 104 determines, for each area, the difference between the number of vehicles that are currently on standby and the predicted number of vehicles (50 for the area A, 30 for the area B, 10 for the area C, and 20 for the area D).

In the example of FIG. 12A, the number of available vehicles (the number of vehicles that are currently on standby) out of the vehicles of which current location information has been obtained by the obtaining unit 102 is 2 at every spot P1, P2, P3, P4. The determining unit 104 determines, for each spot, the difference between the number of vehicles that are currently on standby and the predicted number of vehicles (12 for the spot P1, 5 for the spot P2, 3 for the spot P3, and 10 for the spot P4).

When the difference determined by the determining unit 104 is equal to or smaller than a predetermined threshold in step S105 (step S105 (NO)), the routine returns to step S101 and a process similar to that described above is repeated. When the difference determined by the determining unit 104 is larger than the predetermined threshold (step S105 (YES)), the routine proceeds to step S106.

In step S106, the battery charge monitoring unit 106 determines if the battery charge levels of the vehicles that are currently on standby (available vehicles) are equal to or higher than a predetermined value. When the battery charge levels of the vehicles that are currently on standby are equal to or higher than the predetermined value (step S106 (YES)), the routine proceeds to step S108. When the battery charge level of any vehicle that is currently on standby is less than the predetermined value (step S106 (NO)), all of such vehicles are transported by a predetermined transporting system (not shown) to a point where they can be charged, and these vehicles are charged at the point (step S107). After the vehicles are charged in step S107, the routine proceeds to step S108. The predetermined value that is used as a reference value for determining if the vehicles need be charged is set to any desired value. For example, the predetermined value may be set to a value required to relocate the vehicles to a high demand spot predicted by the predicting unit 103 (a spot where the predicted number of vehicles is large).

In step S108, the vehicle relocating unit 105 relocates the vehicles to a spot where the number of vehicles predicted by the predicting unit 103 is larger than the predicted number of vehicles at the current location. At this time, the vehicles are preferably relocated in the autonomous drive mode. FIG. 11B and FIG. 12B show the state after the vehicles are relocated by the vehicle relocating unit 105.

FIGS. 11A and 11B show an example in which, when the difference determined by the determining unit 104 (that is, the difference between the predicted number of vehicles that are needed and the number of vehicles that are currently on standby) is larger than 5, the vehicles are relocated so as to reduce the difference. Specifically, the differences in the areas A, B, C, and D shown in FIG. 11A are 20, 25, 2, and 8, respectively. Since the difference is larger than 5 in the areas other than the area C, vehicles that are on standby (available vehicles) around the areas A, B, and D are relocated to the areas A, B, and D, respectively. As a result, as shown in FIG. 11B, the numbers of standby vehicles (the numbers of vehicles that are currently on standby) in the areas A, B, and D are increased, and the differences in the areas A, B, and D are reduced.

FIGS. 12A and 12B show an example in which, when the difference determined by the determining unit 104 (that is, the difference between the predicted number of vehicles that are needed and the number of vehicles that are currently on standby) is larger than 2, the vehicles are relocated so as to reduce the difference. Specifically, the differences at the spots P1, P2, P3, and P4 shown in FIG. 12A are 10, 3, 1, and 8, respectively. Since the difference is larger than 2 at the spots other than the spot P3, vehicles that are on standby (available vehicles) around the spots P1, P2, and P4 are relocated to the spots P1, P2, and P4, respectively. As a result, as shown in FIG. 12B, the numbers of standby vehicles (the numbers of vehicles that are currently on standby) at the spots P1, P2, and P4 are increased, and the differences at the spots P1, P2, and P4 are reduced.

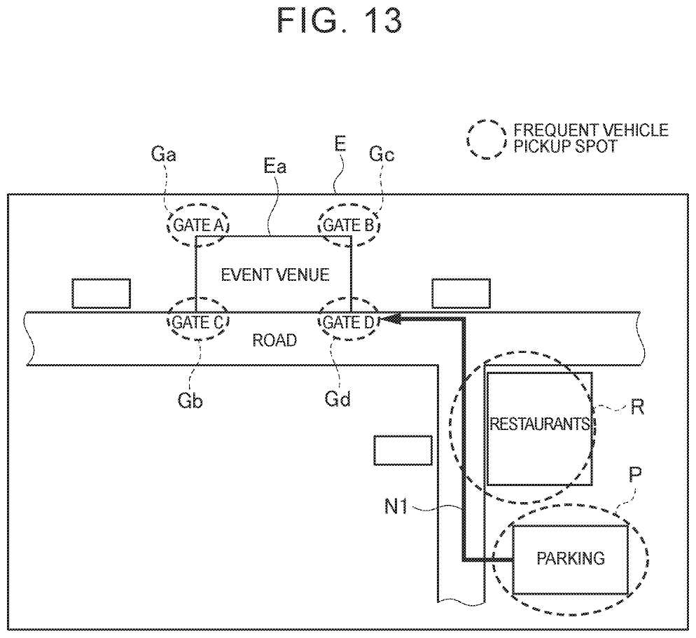

The example of FIGS. 12A and 12B shows frequent vehicle pickup spots in the parking area P in the destination E where an event is held (the destination E including a route R1 from the parking lot to an event venue Ea). However, the disclosure is not limited to this example. For example, any high demand spot within the facility of the destination E may be predicted and the vehicles may be relocated in advance to all of such high demand spots. FIG. 13 shows an example in which the frequent vehicle pickup spots (high demand spots) predicted by the predicting unit 103 are a parking area P, a restaurant area R, areas Ga, Gb, Gc, Gd near the gates of the event venue Ea. In FIG. 13, the areas surrounded by dashed lines indicate these frequent vehicle pickup spots. The vehicles 30 may be stationed in advance such that a large number of vehicles 30 are on standby at these high demand spots predicted by the predicting unit 103. In the case where the predicted number of vehicles is large in a route N1 from the parking lot to the event venue Ea, the vehicles may be stationed around the route N1. When the vehicles are ultra-compact mobility vehicles, it is especially advantageous because the ultra-compact mobility vehicles can travel along the route N1 even if the road along the route N1 is a narrow road (a road through which ordinary cars cannot pass). As described above, by relocating the vehicles to the high demand spots near the event venue Ea where a predetermined event is held, the utilization rate of vehicles can be increased and users' convenience can be improved.

As described above, by using one- or two-seater ultra-compact mobility vehicles that are compact with small turning radii and are smaller than mini-vehicles, the ultra-compact mobility vehicles can be stationed even at places through which ordinary cars cannot pass. Accordingly, for example, in the case where ordinary cars cannot travel within the facility of the destination E where an event is held, the ultra-compact mobility vehicles can be stationed at the high demand spots within the facility of the destination E as shown in FIGS. 12A, 12B, and 13. This can further improve users' convenience.

In the above embodiments, the vehicles are relocated so as to reduce the difference between the predicted vehicle demand, namely the predicted number of vehicles, and the number of available vehicles. The vehicles can thus be intensively stationed at frequent vehicle pickup spots (high demand spots). This can increase the utilization rate of the vehicles stored in the car sharing system and can improve users' convenience.

The above embodiments are described to facilitate understanding of the disclosure and should not be construed as restrictive.

For example, the configuration of the vehicle equipped with the information processing device is also described in the above embodiments. However, the vehicle may be equipped with a part of the information processing device (e.g., the predicting unit etc.) and may not be equipped with the remainder of the information processing device (e.g., the registering unit etc.), or vice versa. The flowchart and sequence, the elements included in the embodiments, the arrangement, materials, conditions, shapes, and sizes of the elements, etc. are not limited to those described above and may be modified as appropriate. The configurations described in the different embodiments may be partially replaced or combined as appropriate.

What is claimed is:

1. An information processing device, comprising:
a registering unit configured to register information on a destination where a predetermined event is held;
an obtaining unit configured to obtain current location information of vehicles movable around or within the destination;
a predicting unit configured to predict, for each specific area, demand for the vehicles that are needed when the predetermined event is held at the destination;
a determining unit configured to determine, for each specific area, a difference between the number of available vehicles out of the vehicles of which current location information has been obtained by the obtaining unit and the number of vehicles predicted by the predicting unit; and
a vehicle relocating unit configured to relocate the vehicles, when the difference determined for each specific area by the determining unit is larger than a predetermined threshold, so as to reduce the difference.

2. The information processing device according to claim 1, wherein the vehicles are small vehicles that can be relocated from a predetermined point within a facility of the destination to another predetermined point where the demand for the vehicles is higher than that at the predetermined point.

3. The information processing device according to claim 1, further comprising a battery charge monitoring unit configured to monitor battery charge levels of the available vehicles out of the vehicles of which current location information has been obtained by the obtaining unit.

4. The information processing device according to claim 3, wherein, when it is determined by the battery charge monitoring unit that the battery charge levels of the vehicles are equal to or higher than a predetermined value, the vehicle relocating unit relocates the vehicles in an autonomous drive mode to a location where the predicted number of vehicles is higher than the predicted number of vehicles at the current location.

5. The information processing device according to claim 3, wherein:
the vehicle relocating unit includes a transporting system that, when it is determined by the battery charge monitoring unit that the battery charge levels of the vehicles are less than a predetermined value, transports the vehicles to a point that allows the vehicles to be charged; and
after the vehicles transported by the transporting system are charged, the vehicle relocating unit relocates the charged vehicles in an autonomous drive mode to a location where the predicted number of vehicles is higher than the predicted number of vehicles at the current location.

6. The information processing device according to claim 1, wherein:
the vehicle includes an imaging device configured to capture an image within a facility of the destination; and
the predicting unit predicts, for each specific area, the number of vehicles based on the information on the destination where the predetermined event registered in the registering unit is held and information on the image captured by the imaging device.

7. A non-transitory storage medium storing a program that causes a computer to perform a process, the process including:
registering information on a destination where a predetermined event is held;
obtaining current location information of vehicles relocatable to the destination;
predicting, for each specific area, demand for the vehicles that are needed when the predetermined event is held;
determining, for each specific area, a difference between the number of available vehicles and the predicted number of vehicles at the current location; and
outputting, when the difference is larger than a predetermined value, information for relocating the vehicles so as to reduce the difference.
